(19) United States
(12) Patent Application Publication
(10) Pub. No.: US 2002/0054598 A1
(43) Pub. Date: May 9, 2002

(54) Method and apparatus for implementing voice over internet protocol in the refueling environment

(75) Inventor: Tommy W. Lewis, Chesapeake, VA (US)

Correspondence Address: RANDALL J. KNUTH P.C., 3510-A STELLHORN ROAD, FORT WAYNE, IN, 46815-4631, US

(73) Assignee: Tokheim Corporation

(21) Appl. No.: 09/976,308

(22) Filed: Oct. 11, 2001

Related U.S. Application Data
(60) Provisional application No. 60/247,379, filed on Nov. 9, 2000.

(51) Int. Cl. H04L 12/50

(52) U.S. Cl. 370/395.53; 370/386

(57) ABSTRACT

A digital intercom system is integrally provided at each dispenser position of a refueling environment. Each intercom system is enabled for communications with a packet-based network disposed at the service station site. The site operator terminal is similarly equipped with an intercom system that is enabled for communications with the packet-based network, thereby permitting voice communications between the operator terminal and customer. The network is connected to a packet-based network such as a WAN, Internet, or Intranet disposed apart from the refueling site. Remote facilities may access the refueling environment by connecting to the network. In one form, the WAN includes the Internet, the LAN supports Internet Protocol (IP), ATM protocol, or frame relay protocol communications, and both the operator terminal intercom system and the various dispenser intercom systems are so enabled.

### BACKGROUND OF THE INVENTION

1. Field of the Invention

The present invention relates to voice communications within a refueling environment, and, more particular, to a method and system for implementing voice communication capabilities over a packet-based data network, such as voice transmissions formatted according to the Internet Protocol (IP), or alternatively asynchronous transfer mode protocol (atm) and frame relay, thereby configuring the refueling environment for Voice over IP (“VoIP”) functionality.

2. Description of the Related Art

Commercial enterprises that engage the customer through personal interaction as part of a retail transaction are increasingly looking towards technology that can optimize the efficiency and functionality of interactive voice communications apparatus to better enhance the purchasing experience. For example, current hardware and software vendors are attempting to manufacture products that can digitize and process voice streams such as those originating from a customer interacting via an interface module.

In a refueling environment, a transaction-related exchange of information may typically take place between a point-of-sale (POS) operator and a customer located at a fueling position. However, conventional intercom systems are configured separately from the dispenser, thus requiring a separate communications channel to be established. For example, in a wired or fixed line setting, another physical line must be run from the intercom position to the operator terminal inside the store.

Wireless communication channels such as radio frequency (RF) and infrared are not a satisfactory alternative since wireless transmissions in some cases are typically subject to interference.

### SUMMARY OF THE INVENTION

According to the present invention there is provided a digital intercom system integrally provided at each dispenser position within a refueling environment. Each of the various intercom systems are enabled for communications with a packet-based local area network (LAN) disposed at the service station site. The site operator terminal is similarly equipped with an intercom system that is likewise enabled for communications with the packet-based LAN, thereby permitting voice communications between the operator terminal and customer via their respective intercom systems.

The LAN is preferably connected via a suitable network attachment device to a packet-based wide area network (WAN) disposed apart from the refueling site. Remote facilities may access the refueling environment by connecting to the packet-based WAN. In a preferred form, the WAN includes the Internet (which employs TCP/IP), the LAN supports Internet Protocol (IP) communications, and both the operator terminal intercom system and the various dispenser intercom systems are Internet Protocol (IP) enabled.

The invention, in one form thereof, is directed to a system comprising a refueling environment for operatively dispensing fuel, in which the refueling environment includes a plurality of dispenser positions. The system further includes a packet-based data network and at least one intercom system each operatively associated with a respective one of the dispenser positions. Each intercom system is operatively connected to the network and is enabled for communications therewith.

In a preferred form, the network comprises the Internet and each intercom system is Internet Protocol (IP) enabled. Alternative networks may include private networks called Intranets. Everything within the fueling station could be on one or more Intranets. The station and any remote sites might be interconnected using one or more Intranets, the Internet, or some combination of Intranets and the Internet. Additionally, each intercom system preferably includes at least one microphone and at least one speaker.

The system, in another form thereof, further includes a remote terminal disposed apart from the refueling environment. The remote terminal is operatively connected to the packet-based data network and is enabled for communications therewith.

A storage means is preferably connected to at least one of the network and the intercom system to accessibly store voice messages and other such communications.

The system, in another form thereof, further includes an intercom system operatively associated with an operator terminal. The operator terminal intercom system is operatively connected to the packet-based data network and is enabled for communications therewith.

The packet-based data network, in another form thereof, further comprises, in combination, a packet-based local area network (LAN) disposed in the refueling environment and operatively connected to each respective one of the dispenser intercom systems; a packet-based wide area network (WAN) disposed apart from the refueling environment; and a network connection arranged to operatively connect the packet-based LAN to the packet-based WAN.

One advantage of the present invention is that by employing intercom systems enabled for communications with Internet Protocol networks, it becomes possible for remote service facilities to gain voice-based access to the individual customers and station operators using the Internet.

Another advantage of the present invention is that verbal communications between the customer at a fueling position and the POS operator are made simpler and more feasible by integrating the IP-enabled digital intercom into the dispenser position and connecting it to an IP local area network.

A further advantage of the invention is that by incorporating a Voice over IP (“VoIP”) functionality into the refueling environment, the dispenser systems are made interoperable with various networks and applications based upon the IP scheme.

A yet further advantage of the invention is that any form of packet-based communications protocol may be used as the basis for network-enabling the refueling environment.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram illustration of a voice communications systems for use in a refueling environment, in accordance with the present invention;

FIG. 2 is a block diagram illustrating one implementation of the intercom system employed in the voice communications system of FIG. 1; and

FIG. 3 is a block diagram illustration of a networking system according to the present invention that utilizes the voice communications system of FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

By way of background, the present invention is preferably used in conjunction with a fuel dispenser environment including a plurality of individual dispenser positions having a conventional arrangement. For example, each dispenser may include a controller to manage the operations of the dispenser position, an input mechanism enabling a customer to make transaction and payment selections (i.e., input device and card reader), and fuel dispensing equipment (i.e., a fuel pump assembly, a metering device, and a vapor recovery assembly). Peripheral equipment may also be included such as printer and audio/video apparatus. Monitoring equipment may be employed to collect data relating to items such as machine status, diagnostic results, and performance measurements.

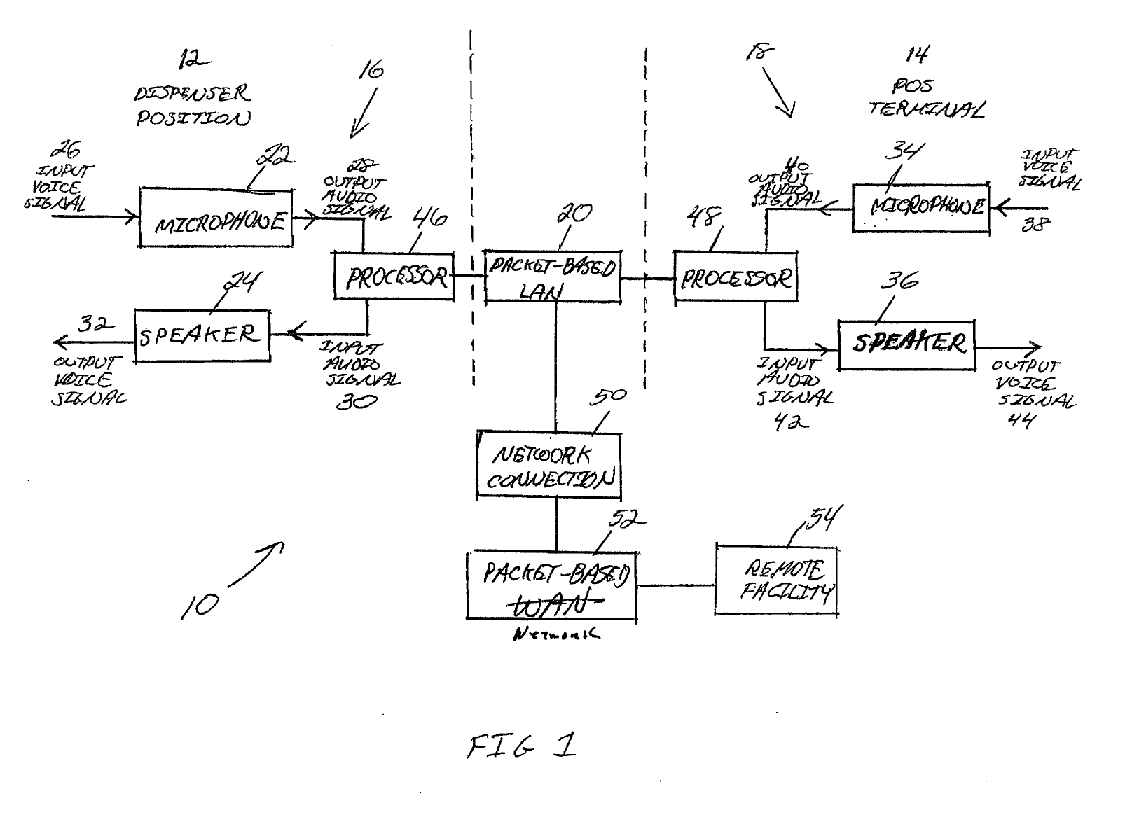

Referring now to the drawings and particularly to FIG. 1, there is shown a voice communications system 10 implemented within a refueling environment for establishing voice-based communications between a customer located at an illustrative dispenser position 12 and an operator located at an illustrative point-of-sale (POS) terminal 14, in accordance with the present invention.

More particularly, the illustrated voice communications system 10 includes, in combination, an intercom and signal processing apparatus 16 integrally provided within a respective dispenser position 12, and an intercom and signal processing apparatus 18 integrally provided with POS operator terminal 14. The dispenser intercom 16 and POS intercom 18 are connected over a communications facility preferably provided in the form of a packet-based data network, namely, packet-based local area network (LAN) 20. It is apparent, then, that voice signals generated by the intercom facilities may be communicated over a data network, i.e., LAN 20.

Although not depicted in FIG. 1, it should be understood that each other dispenser position within the refueling environment is preferably provided with an integral intercom apparatus 16 and is similarly connected to LAN 20. Accordingly, the discussion herein relating to the system of FIG. 1 applies equally to the other dispenser positions within the refueling environment.

The illustrated dispenser intercom 16 includes an audio signal detection means provided in the form of a microphone 22, and an audio signal reproduction means provided in the form of a speaker 24, both preferably having a conventional construction adapted for use in a refueling environment. In particular, microphone 22 is adapted in a known manner to receive acoustic signals generated by the customer (i.e., input voice signal 26) and generate an output audio signal 28 representative thereof. Speaker 24 is adapted in a known manner to reproduce an input audio signal 30 as output voice signal 32 for audible reception by the customer. Input audio signal 30, for example, may correspond to a voice communication issued by an operator at POS terminal 14.

Similarly, the illustrated POS intercom 18 includes an audio signal detection means provided in the form of a microphone 34, and an audio signal reproduction means provided in the form of a speaker 36, both preferably having a conventional construction adapted for use in a POS facility. Microphone 34 is adapted in a known manner to receive acoustic signals generated by the operator (i.e., input voice signal 38) and generate an output audio signal 40 representative thereof. Speaker 36 is adapted in a known manner to reproduce an input audio signal 42 as output voice signal 44 for audible reception by the operator. Input audio signal 42, for example, may correspond to a voice communication issued by a customer at one of the dispenser positions 12.

According to a preferred feature of the present invention, the voice channel established by packet-based LAN 20 requires that both the dispenser intercom 16 and POS intercom 18 be configured for communications over LAN 20. In particular, any attempted transmission or reception of voice-related signals using LAN 20 requires adherence and any other such compliancy with the signal communications format and protocol supported by LAN 20.

For this purpose, each intercom apparatus is provided with a suitable processing facility for performing the requisite encoding and decoding operations needed to prepare voice signals for transmission over LAN 20 and to recover the underlying voice signal embedded within the received transmissions. In particular, dispenser intercom apparatus 16 is configured with a processor 46, while POS intercom apparatus 18 is equipped with a processor 48.

By way of illustration, dispenser intercom processor 46 would process output audio signal 28 into a form suitable for transmission over LAN 20. For example, as known to those skilled in the art, this encoding-type process typically involves digitization of the detected audio signal and then packetization of the digital signal to create a packet stream suitable for transmission over LAN 20. Additionally, in a decoding-type manner, processor 46 would process a voice-related packet stream received from LAN 20 and reconstruct it into a form suitable for use by speaker 24.

In similar fashion, POS intercom processor 48 would process output audio signal 40 into a form suitable for transmission over LAN 20. Additionally, processor 48 would process a voice-related packet stream received from LAN 20 and reconstruct it into a form suitable for use by speaker 36.

This manner of equipping each intercom apparatus for compatibility and compliancy with the communications protocol of packet-based data LAN 20 may be understood as enabling each intercom apparatus for communications with LAN 20. For example, when LAN 20 employs the Internet Protocol (IP), each of the dispenser intercom 16 and POS intercom 18 becomes IP-enabled. However, it should be apparent that LAN 20 may be provided in any form having any type of packet-based data communications protocol. For example, in addition to Internet Protocol, both Frame Relay and ATM (Asynchronous Transfer Mode Protocol) may be used.

Further details relating to the manner of transporting voice over IP networks may be found in The Technology Guide Series—Voice over IP (VOIP) by The Applied Technologies Group, Inc. of Natick, Mass. (1998), incorporated herein by reference thereto. Other information may be available at the following company Web Site address: http://www.techguide.com.

The illustrated system 10 preferably includes a network attachment device provided in the form of a network connection 50 suitable for use in connecting packet-based LAN 20 to a packet-based wide area network (WAN), such as the Internet. Connected to WAN 52 is an illustrative remote facility 54.

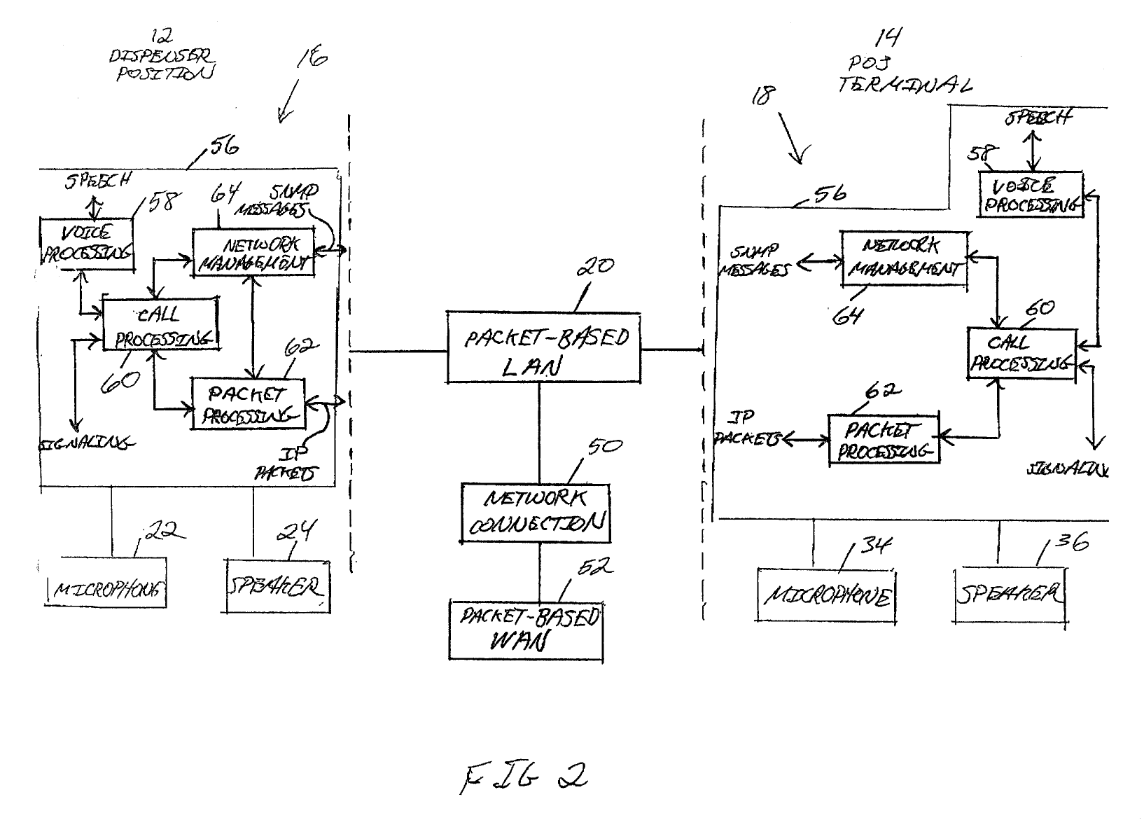

Referring now to FIG. 2, there is shown one illustrative implementation of processor 46 and processor 48 of FIG. 1. In particular, the illustrated processing arrangement 56 configured for use in dispenser intercom 16 includes software applications comprising, in combination, a voice processing module 58, a call processing (signaling) module 60, a packet processing module 62, and a network management module 64.

The illustrated voice processing module 58 prepares voice samples for transmission over the packet network (i.e., LAN 20) and typically is implemented as software executable on a digital signal processor (DSP). The illustrated call processing module 60 serves as s signaling gateway allowing calls to be established across the packet network. The illustrated packet processing module 62 processes the voice and signaling packets, and adds the appropriate transport headers prior to submitting the packets to the packet-based network. The illustrated network management module 64 provides management agent functionality, allowing remote fault, accounting, and configuration management to be performed from standard management systems. Further information may be found in the aforementioned Technology Guide Series—Voice over IP (VoIP), specifically at pp. 19 et seq.

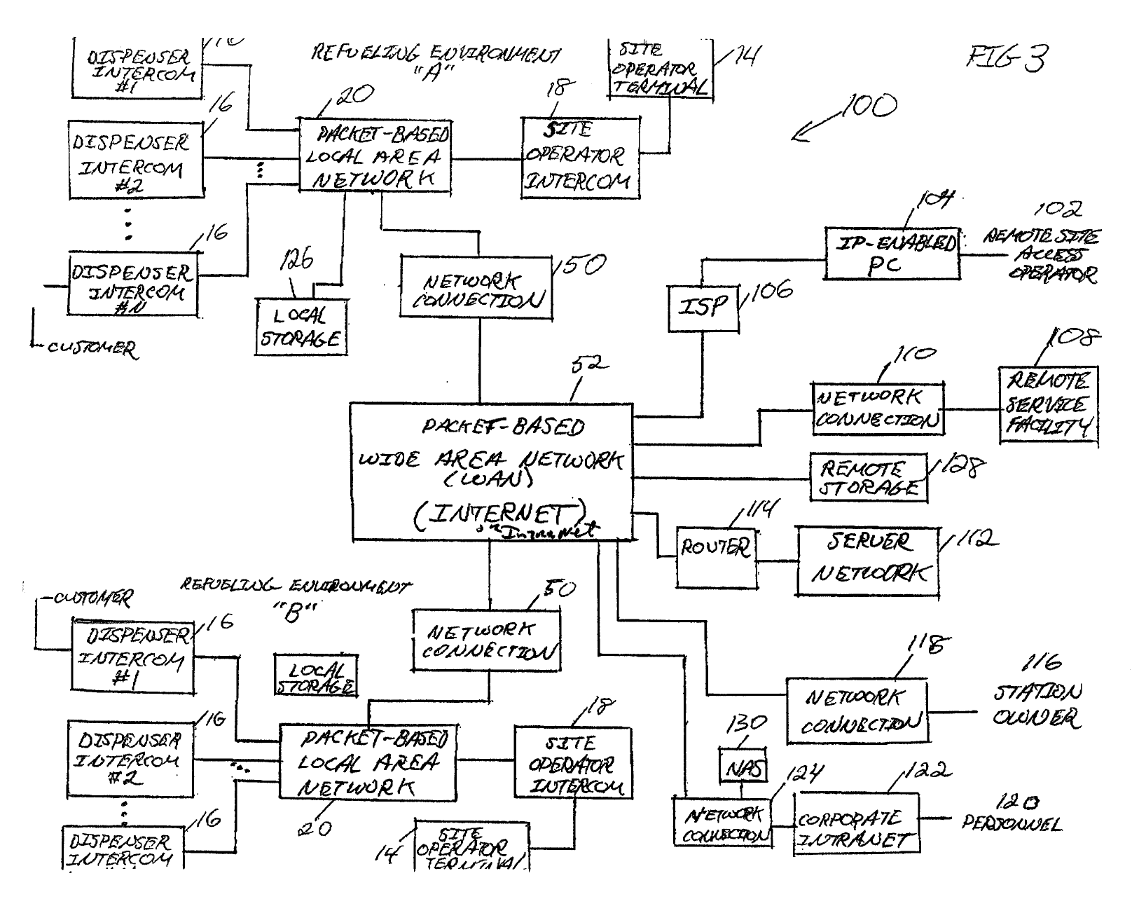

Referring now to FIG. 3, there is shown a voice-enabled networking architecture 100 associated with various refueling environments that employ the intercom-based voice communications system 10 of FIG. 1. As discussed in connection with FIG. 1, the voice communications system 10 provides a voice link between the customer (at illustrative dispenser position 12) and an operator (at illustrative POS terminal 14).

The illustrated networking architecture 100 includes at a representative refueling environment “A” a plurality (N) of dispenser intercom systems 16 each associated with a respective fuel dispenser position and connected to packet-based LAN 20, which preferably employs an IP communications format. As shown, voice communication access characterized as one-to-any may be established between site operator terminal 14 and any one of the dispenser intercoms 16 via LAN 20.

A plurality of refueling environments (i.e., individual service station sites) may be connected to one another via the packet-based WAN 52, which preferably includes the Internet. Accordingly, voice communication access characterized as any-to-any may be established between any site operator terminal (e.g., at refueling environment A) and any other site operator terminal (e.g., at refueling environment B) via the communications link that involves the respective POS intercoms 18, the respective network connections 50, and the Internet 52.

Additionally, with the deployment of a wide area network 52 such as the Internet and its access to the various local refueling environments via the appropriate network connections 50, it becomes possible for remote operators and facilities to gain voice communications access to the customers and site operators. For example, a remote site access operator 102 may gain voice access to any station operator and/or customer at any refueling environment by connecting to the Internet 52 using an IP-enabled personal computer (PC) 104 and an Internet Service Provider (ISP) 106 such as America Online (AOL). For this purpose, PC 104 may be equipped with a voice-handling or processing capability.

Additionally, a remote service facility 108 may implement such any-to-any accessibility vis-a-vis the plural station operators and customers using the appropriate network connection 110. For this purpose, the remote service facility 108 may be provided with a suitable IP-enabled intercom system.

A network of servers 112 may be connected to the Internet 52 using a conventional router 114 such as one from Cisco Systems. The server network 112 may be used to develop a client-server communications model in which the dispenser positions and/or POS terminals function as client devices.

A station owner 116 connected to the Internet over suitable network connection 118 may conduct voice communications with any one of the site operators at any one of the refueling environments as part of a monitoring operation. In a similar fashion, corporate personnel 120 logged on to the Internet 52 via a corporate intranet 122 and network connection 124 may have voice communications access to any other entity networked to Internet 52.

In order to facilitate rapid voice communications access across the entire networking architecture 100, it is preferable to make each entity network-addressable, such as by assigning IP addresses to each entity, e.g., the individual dispenser intercoms, POS intercoms, and any other networked devices (e.g., network-attached storage units).

It is a feature of the present invention that all forms of voice communications encompassed by the present invention are preferably conducted in real-time.

What is apparent from the illustrated networking configurations of FIGS. 1-3 is that the types of voice communication access characterized as one-to-any and any-to-any may be established between the following entities: (1) a POS intercom and any other dispenser intercom in the same or different refueling environment; (2) POS intercoms belonging to different refueling environments; and (3) a remote intercom facility and any POS intercom, dispenser intercom, and/or any other remote audio-capable facility.

One enhancement to the systems shown in FIGS. 1-3 involves the use of storage facilities connected to the network for purposes of implementing storage-based applications such as email messaging and voice mail. For example, if a local storage unit 126 is connected to LAN 20, any of the digitally formatted voice communications being handled by LAN 20 may be routed to storage area 126. A site operator may use this feature to develop a voice-based e-mail message that is stored in local storage 126 and subsequently retrieved and played back by an employee using POS intercom 18. Additionally, a remote operator may also leave a voice mail message within local storage 126 by remotely accessing this device over Internet 52 and LAN 20.

Similarly, the installation of a stand-alone remote storage area 128 and network attached storage (NAS) medium 130 (such as one available from Network Appliances) connected to intranet 122 may enable locally generated voice communications to be transported over the LAN 20 and Internet 52 to reside at remote sites for archival or later retrieval.

One advantageous use of the present invention involves the implementation of a voice-activated system for performing such tasks as operating the dispenser and conducting a service check pursuant to a diagnostic procedure. For example, a voice-activated repository of service bulletins and instructions may be provided to assist the diagnostic personnel. A service technician could verbally navigate through the trouble flowcharts and other diagnostic options after establishing a voice communications channel with the voice-activated system using the dispenser intercom. For this purpose, the voice-activated system would be attached to and thereby made accessible from the local area network. After reaching the appropriate service bulletin and accompanying instructions, a technician equipped with a portable, hands-free intercom headset could quickly perform the required task.

Other voice-activated systems might include a voice-activated pump and voice-based transaction execution. Additionally, as a security feature, the collected voice samples could be used to provide user authentication and validation as part of an authorization procedure.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system, comprising:
a refueling environment for operatively dispensing fuel, said refueling environment including a plurality of dispenser positions;
a packet-based data network; and
at least one intercom system each operatively associated with a respective one of said plurality of dispenser positions;
each intercom system being operatively connected to said network and being enabled for communications therewith.

2. The system as recited in claim 1, wherein said network comprises an Intranet.

3. The system as recited in claim 1, wherein said network comprises the Internet.

4. The system as recited in claim 2, wherein each intercom system being Internet Protocol (IP) enabled.

5. The system as recited in claim 4, wherein each intercom system respectively comprises at least one microphone and at least one speaker.

6. The system as recited in claim 1, further comprises:
a remote terminal disposed apart from said refueling environment, said remote terminal being operatively connected to said network and being enabled for communications therewith.

7. The system as recited in claim 1, further comprises:
a storage means operatively connected to at least one of said network and said intercom system.

8. The system as recited in claim 1, further comprises:
an intercom system operatively associated with an operator terminal, said operator terminal intercom system being operatively connected to said network and being enabled for communications therewith.

9. The system as recited in claim 1, wherein said network comprises:
a packet-based local area network (LAN) disposed in said refueling environment and being operatively connected to each respective one of said at least one intercom system;
a packet-based wide area network (WAN) disposed apart from said refueling environment; and
a network connection arranged to operatively connect said packet-based LAN to said packet-based WAN.

10. The system as recited in claim 3, wherein each intercom system being ATM protocol enabled.

11. The system as recited in claim 3, wherein each intercom system being frame relay protocol enabled.

12. The system as recited in claim 1, wherein said network comprises:
a packet-based Intranet disposed in said refueling environment and being operatively connected to each respective one of said at least one intercom system;
a packet-based Internet disposed apart from said refueling environment; and
a network connection arranged to operatively connect said packet-based Intranet to said packet-based Internet.
